(19) United States
(12) Patent Application Publication
(10) Pub. No.: US 2013/0155053 A1
(43) Pub. Date: Jun. 20, 2013

(54) MULTI-DIMENSIONAL VISUAL DISPLAY INTERFACE

(71) Applicants: Steven Michael BECK, Fairfax, CA (US); Carl L. JABLONSKI, San Dimas, CA (US); John D. HOGAN, Livermore, CA (US)

(72) Inventors: Steven Michael BECK, Fairfax, CA (US); Carl L. JABLONSKI, San Dimas, CA (US); John D. HOGAN, Livermore, CA (US)

(73) Assignee: VIRUAL WORLD & SUNS, LLC, SAN DIMAS, CA (US)

(21) Appl. No.: 13/610,057

(22) Filed: Sep. 11, 2012

Related U.S. Application Data
(60) Provisional application No. 61/537,713, filed on Sep. 22, 2011.

(51) Int. Cl. G09G 5/00

(52) U.S. Cl. CPC G09G 5/006
USPC 345/419

(57) ABSTRACT

A display having a dynamic three dimensional display space is provided to display documents, such as WebPages. The display includes an automatic visual movement through the three dimensional display space with documents being clickable to allow interaction. In an engage mode, data input into a selected webpage of the documents is used to control which documents are presented in the three dimensional display space.

### CLAIM OF PRIORITY

This application claims priority to U.S. Provisional Application No. 61/537,713, entitled “MULTI-DIMENSIONAL VISUAL DISPLAY INTERFACE” by Steven Michael Beck, et al., filed on Sep. 22, 2011.

### FIELD OF THE INVENTION

The present invention relates to information display systems such as but not limited to FaceBook and other such Social Media using stored data such as but not limited to photographs.

### BACKGROUND

Information display systems are systems for the display and interaction with information. An example is a computer display of Internet content. Typically, a user searches using a search engine to find pages related to a search. Text or thumbnails of the found pages are then displayed allowing the user to click on and view the displayed pages.

### SUMMARY

Embodiments of the present invention use a three dimensional display space. Documents such as web pages are displayed within the three dimensional display space. The three dimensional display space can include a view of a room or rooms that are automatically moved through allowing for the display of the documents. The documents thus pass by the user increasing in apparent size until the viewing position passes the document. The documents can be arranged to appear to float in space within parallel view-aligned and orthogonal planes arranged around the path of movement in the three dimensional display spaces.

The display can be of a television such as notebook screens, computer monitors, mobile touch devices and High Definition Televisions (HDTV). A computer system can be used to generate the display. A controller like a remote control, a direct touch screen or a keyboard can be used to interact with the display.

The display uses a variety of modes. A start up mode displays personal documents such as but not limited to pictures, music and movies. An explore mode is used to input search terms and display documents, such as web pages, related to the search terms. A discover mode is a search mode with a greater density of displayed documents. An engage mode allows a user to input data into a webpage and display that webpage in the three dimensional space within floating frames. Additional floating frames will add layers of new data, related to the original website search.

The system is a leisure based, consumer interface designed to present search results in their original visual form: as fully realized designs or graphic data, not thumbnails nor text. As the system presents its findings, it ‘echoes’ associated, influential visual data upon its surrounding, endless, visual array.

This approach, presented within a stylized, three dimensional environment, is designed to create an entertainment experience from task based searching. By applying a cinematic bent to the system's presentation, its interface feels more “cinematic” than anything else, more of a movie, more of a game. This creates entertainment experiences out of ordinary functionality.

### BRIEF DESCRIPTION OF THE DRAWINGS

FIG. 1 shows a system of one embodiment of the present invention.

FIGS. 2A and 2B show display screens of embodiments of the present invention.

FIGS. 3A and 3B show examples of mode selection of one embodiment of the present invention.

FIG. 4 shows a selectable keyboard for inputting search terms in an explore mode.

FIG. 5 shows a display of stored web page documents.

FIG. 6 shows a display of engage mode interaction with a web page.

FIG. 7A-7C show exemplary control icons for an embodiment of the present invention.

### DETAILED DESCRIPTION

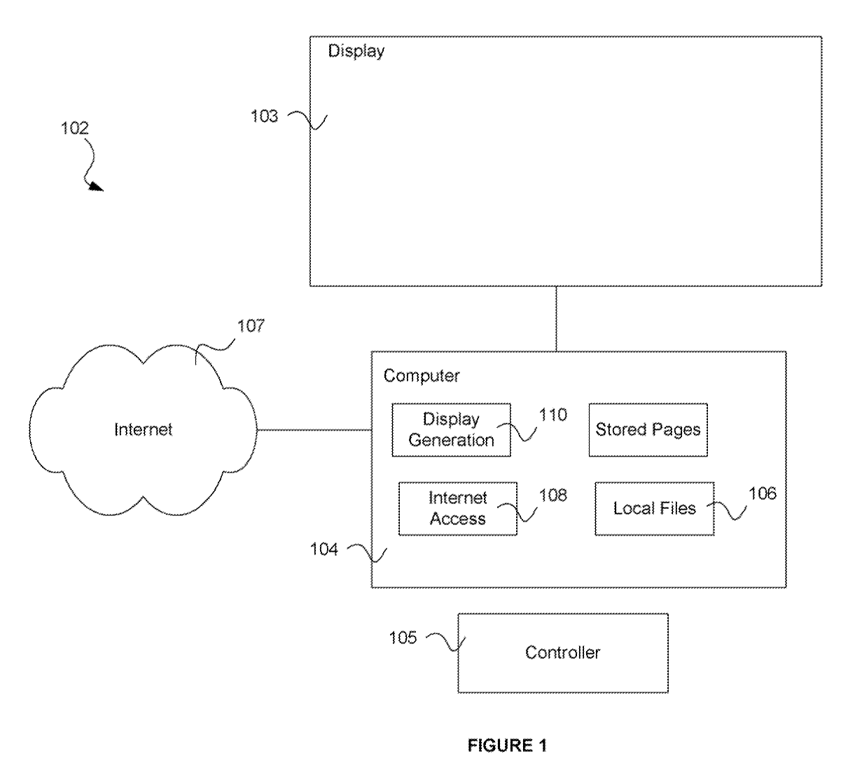

FIG. 1 shows a display system 102 of one embodiment of the present invention. The display is done on a screen 103 such as a television or computer screen. In one embodiment, the screen 103 is a high definition television (HDTV). The screen 103 is connected to a computer 104. The computer 104 can be stand alone or integrated within a HDTV or other television set. Alternatively, the screen can be on a mobile device such as an iPad.

The computer 104 is connected to the Internet 107 to access WebPages and other documents. The computer 104 also stores local files 106 such as personal documents including photos. Internet access code 108 can be used by the display generation code 110 to access the Internet 107. The display generation code 110 can produce displays as described below. The display generation code 110 renders the three dimensional display space and inserts displayed documents. A controller 105 such as a TV remote, smart phone, iPad or keyboard can be used to interact with the display.

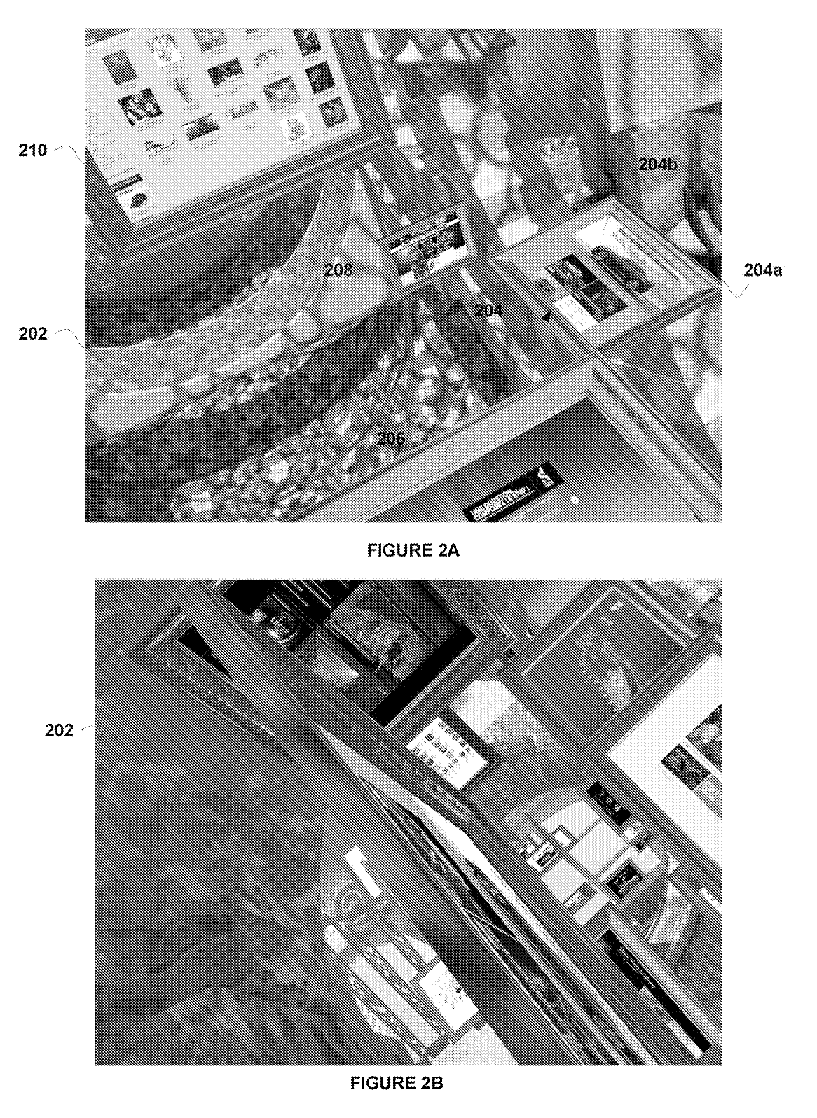

In one embodiment, a dynamic three dimensional display space 202 is rendered as shown in FIGS. 2A and 2B. This display space 202 includes documents 204, 206 208 and 210. The display space 202 includes an automatic visual movement through the three dimensional display space 202 with documents 204, 206 208 and 210 being clickable to allow interaction. Interactions include the storing of documents and opening documents to input data or for closer viewing.

The documents 204, 206 208 and 210 are displayed such that they appear to float within the three dimensional space. Three dimensional picture frames, such as frame 204a, are rendered to highlight the flat webpage documents, such as document 204b. The documents can be arranged in different planes within the three dimensional space. In one embodiment, the documents are arranged in parallel and orthogonal planes around the view path through the three dimensional display space. Detailed three dimensionally rendered objects can also be put in the three dimensional display space.

FIG. 2B shows another view within the display space 202 with other displayed documents. The three dimensional display space can be rendered to be displayed on a normal or 3D television.

An on-ramp experience is a film based transition designed to transfer the user from their traditional operating system/browser to the unique environmental presentation of the system.

Once inside this environment, the system's interface quickly introduces the user to its multiple frames of information, or its EDA (Endless Display Array)—the endless number of the system's gold, gilt frames. Presented in Computer Generated Imagery (CGI), this vast array has the ability to showcase both live streaming data, or stored information, or both. The EDA also has the ability to sense surrounding information and redirect its presentation results and reflect these influences as they “flow by”.

Once within the system, the start up or “dream” mode is the introductory mode of its interface. Designed to display the user's graphic information and music files within its EDA as it idles, awaiting search instruction, this continuous shuffle of imagery conjures up memories of “scrapbook” functionality.

But in the system's case, its scrapbook—the dream mode—is embedded within a dimensional environment, creating a surreal presentation of personal information, instead of a one dimensional shuffle of images. Here, the user is the subject of its museum-esque presentation.

In this mode, the system has the ability to run continuously, showcasing/shuffling the user's graphic data as the user's point of view literally flies through the system's unique environment. The system is capable of other themed environments, limited only by the imagination.

At the same time, the interface is shuffling through selected audio files—soundtracks designed to embellish the rich experience.

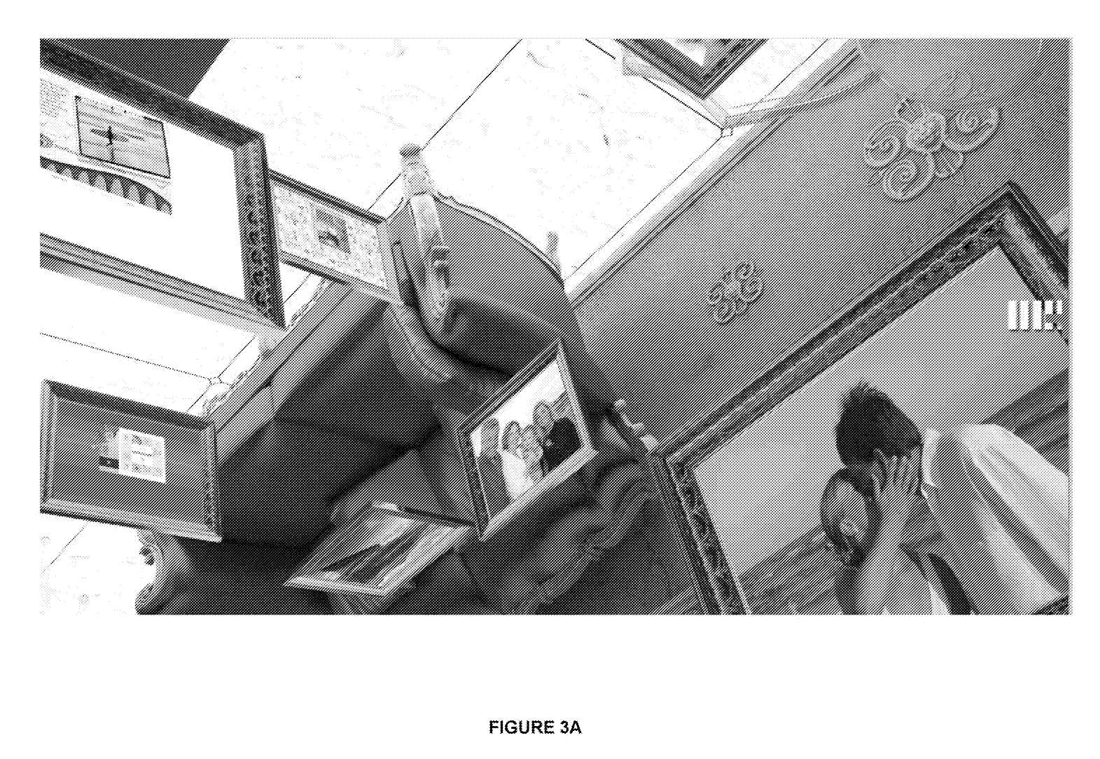

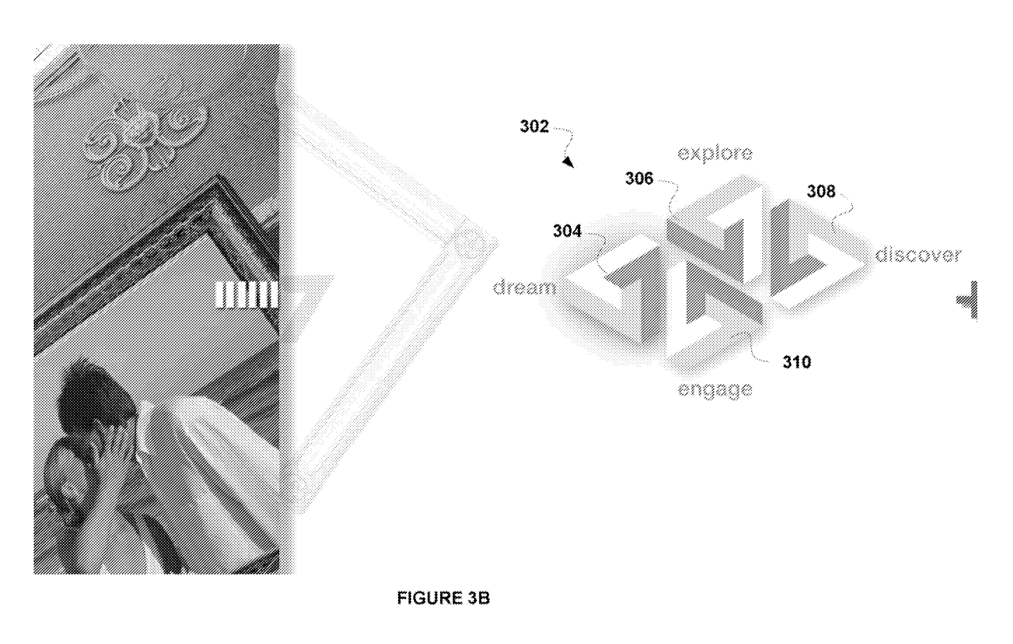

A number of selectable modes are used to control which documents are displayed. FIGS. 3A and 3B show the selection of a mode select control tray display 302. The mode select display 302 allows the selection of a start up, or dream mode, with icon 304; an explore mode with icon 306; a discover mode with icon 308; and an engage mode with icon 310.

To open the control tray 302, the user “swipes” using an on-screen touch motion the right edge of the browser window as shown in FIG. 3A. “Swiping” on the tab that then presents itself, the tray opens (from right to left), pausing the system's film display experience.

Now open, displayed will be the system's control tray 302 and its options of use: dream mode, explore mode, discover mode, and engage mode.

In a start up, or dream, mode personal documents of a user are displayed as discussed above. The personal documents can include photos, music or movies. In an explore mode, documents related to an input search term are displayed. In a discover mode, documents related to the input search term are displayed with a greater density in the three dimensional space. In one embodiment, the density in the discover mode is three times as great as in the explore mode In an engage mode, data input into a selected webpage of the documents is used to control which documents are presented in the three dimensional space.

Clicking on a system screen icon launches the interface.

Within the user's open internet window—be it Safari, Chrome, Bing, etc.—upon its initiation, the system first stores the current screen data, caching it. With this “snap shot” data in hand, the program then texture maps this information onto the appropriate geometry, “disassembling and reconfiguring it” into the initial, purely visual, onramp experience.

The user then has the option to choose from the system's various modes, or by closing the tray without selecting another mode, the interface will return to the last mode.

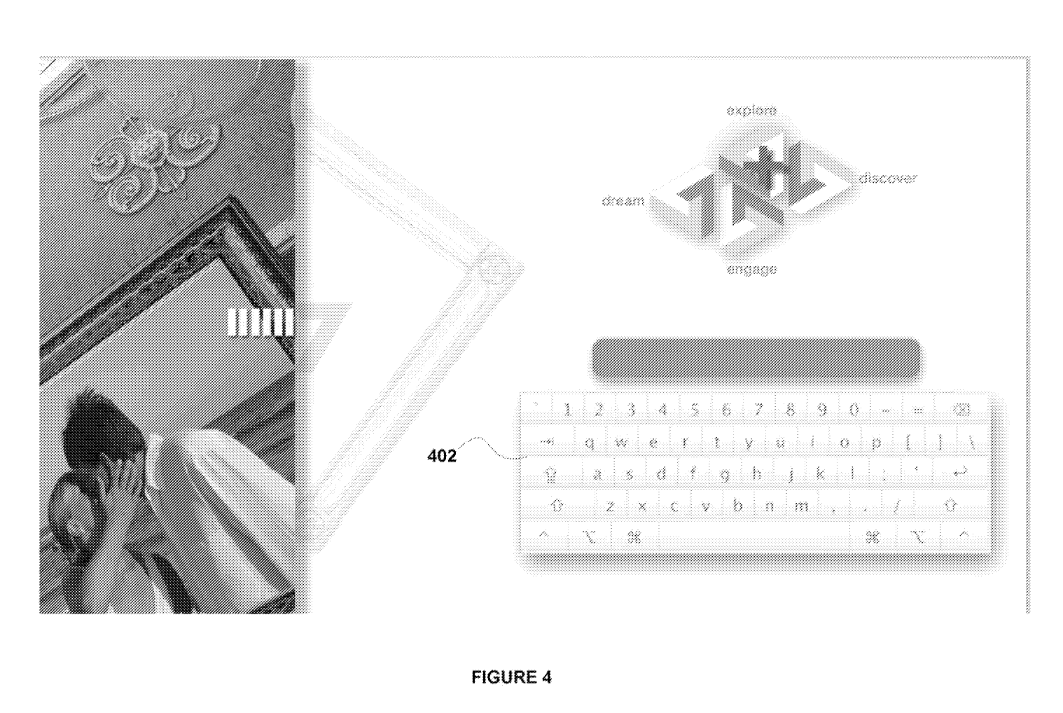

FIG. 4 shows the selection of the explore mode. In the explore mode, the user can use the displayed keyboard interface 402 to input search terms.

As the explore mode is chosen, the system's virtual keyboard 402 rises into frame of the controller tray, displayed so the user can type in any search topic into it the search window by using either their TV remote, their iPad or tablet keyboard, or their thumb keyboard in the case of mobile devices. Once chosen, the system control tray can be closed, resulting in the initiation of the search chosen by the user.

The visual results of that search quickly surfaces in the immediate, surrounding frames, (or the EDA). These are the actual websites, themselves, if one searched for a website.

While inside the active interface, if a user wants to inspect a specific site from the EDA, an on-screen swipe motion or other gesture activates the website will then enter displaying a full frame in the immediate foreground, re-presented up close for better inspection by the user. Once inspected, all the user need do is use a swipe motion or other on-screen motion and the site retreats.

From the endless variety of choices displayed in the EDA, the user can then click on the frames desired (any quantity), the selections stored in the system selections tray, much like a bookmark, for inspection later.

To inspect the collection of choices made during explore mode, using the on-screen swipe motion or other gesture on the left edge of frame, opens the selections tray (left to right). Within its window are displayed all the chosen frames, or websites, ‘collected’ by the user.

From these selected sites—displayed as frame icons within the selection drawer—if the user clicks on them, the website is presented full frame after the closing of the selections drawer (or as the program is engaged).

Within the now-active window, the user can explore or exit the website they've chosen, as they continue to “fly through” the system interface.

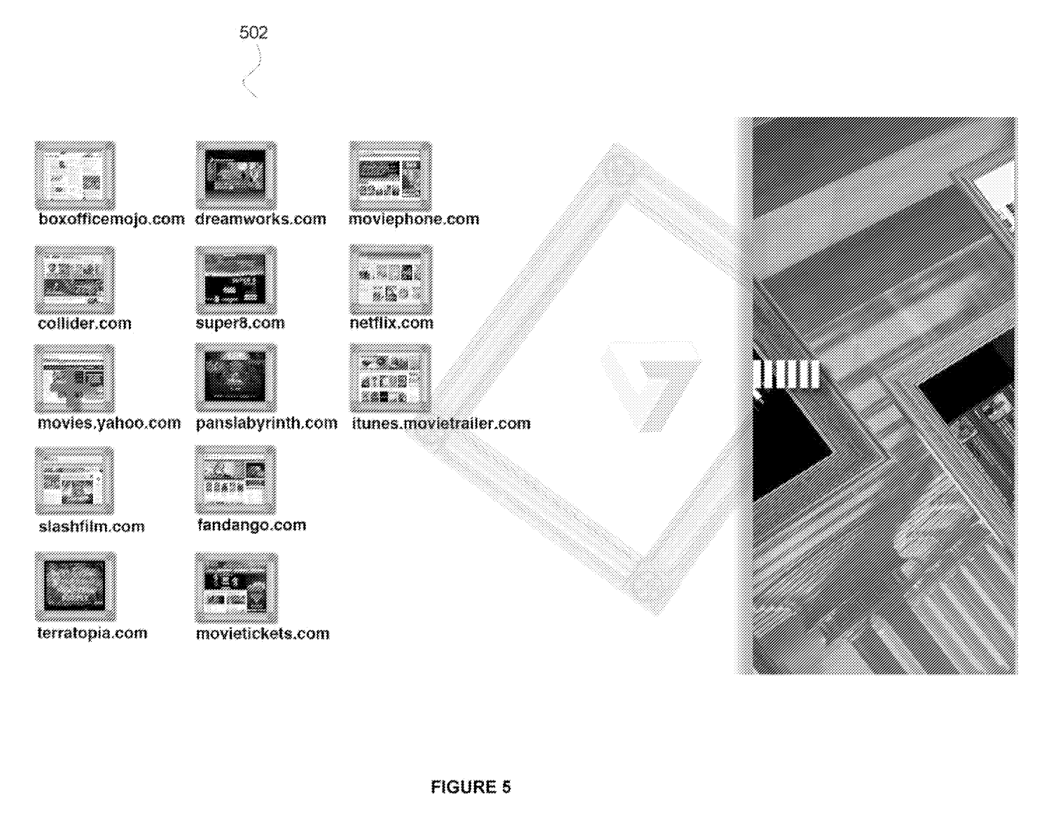

FIG. 5 shows an exemplary display page 502 for the stored documents. The stored documents can then be preferentially displayed in the three dimensional display space. For example, the stored documents can be the first pages displayed in the three dimensional display space.

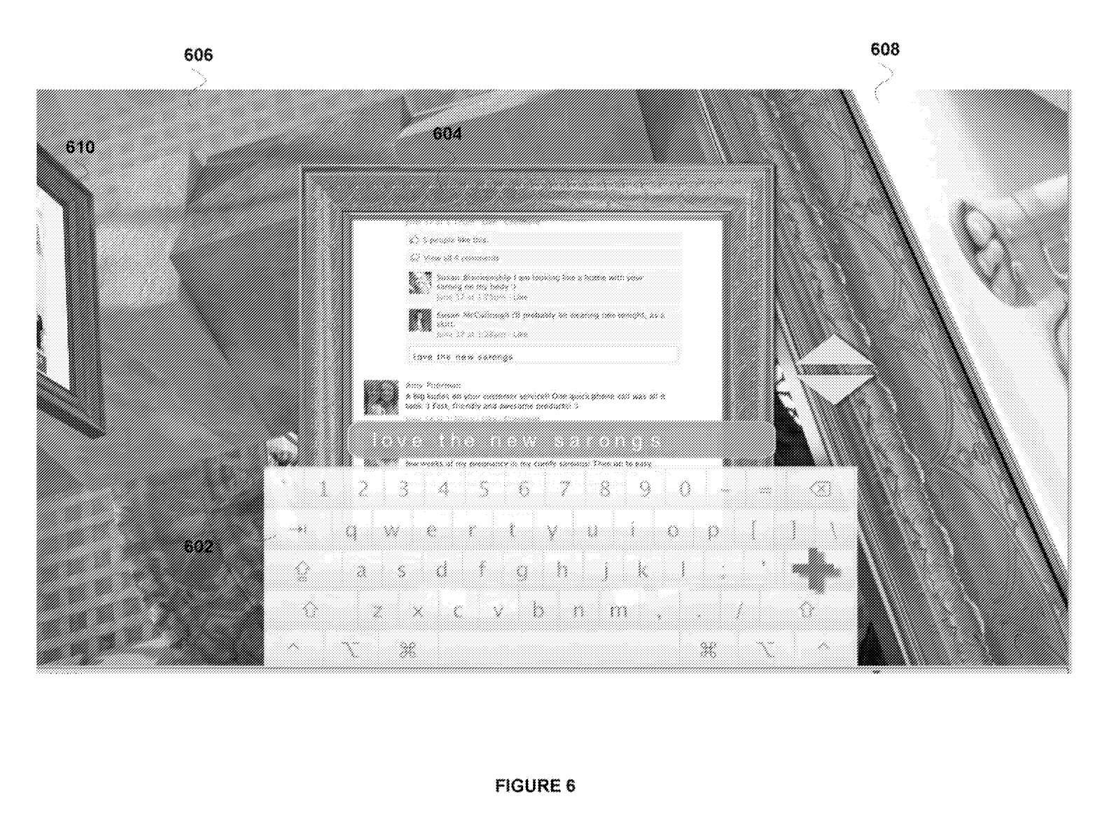

FIG. 6 shows the use of the keyboard interface 602 to input data into the selected web page 604 in an engage mode. The other documents, such as documents 608 and 610, in the three dimensional display space 606 can be updated based on the input data. In the example of FIG. 6, documents 608 and 610 relate to the search term “sarong” input by the user.

In one embodiment, the web page 604 can be a social networking site, such as Facebook. This allows the input to the social network site to be “mirrored” onto other documents.

When the engage mode is chosen, the control tray display changes. In the engage mode, the system acts much more like recorded content, meaning unlike a typical search, with the engage mode you can fast forward, fast reverse, reverse, play, pause, and stop the visual presentation of the system.

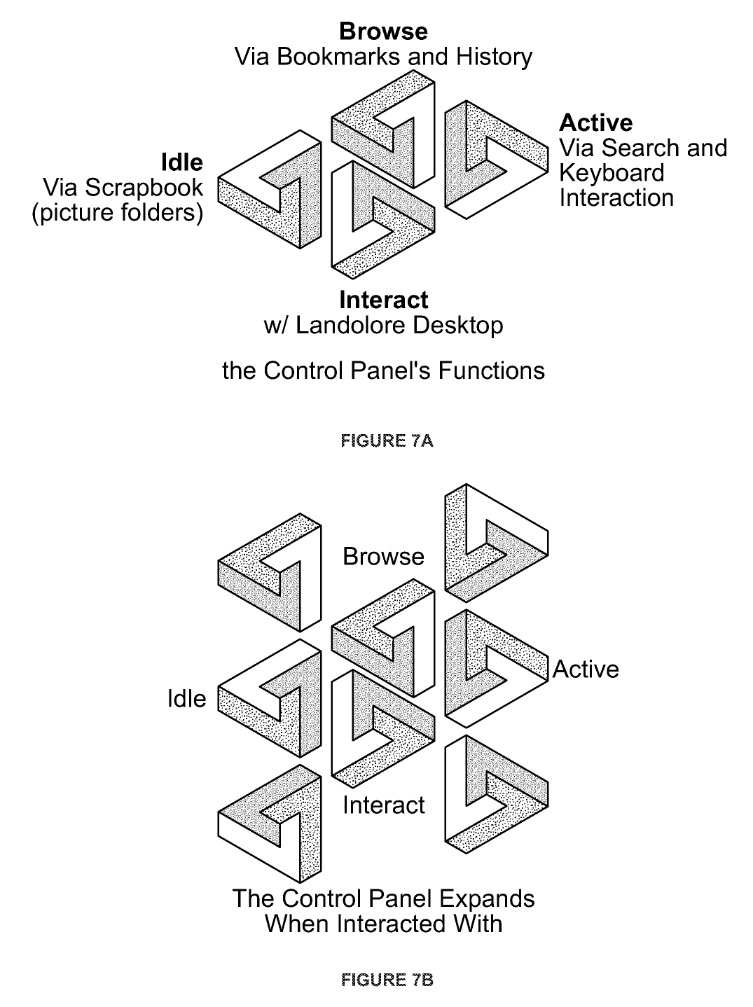

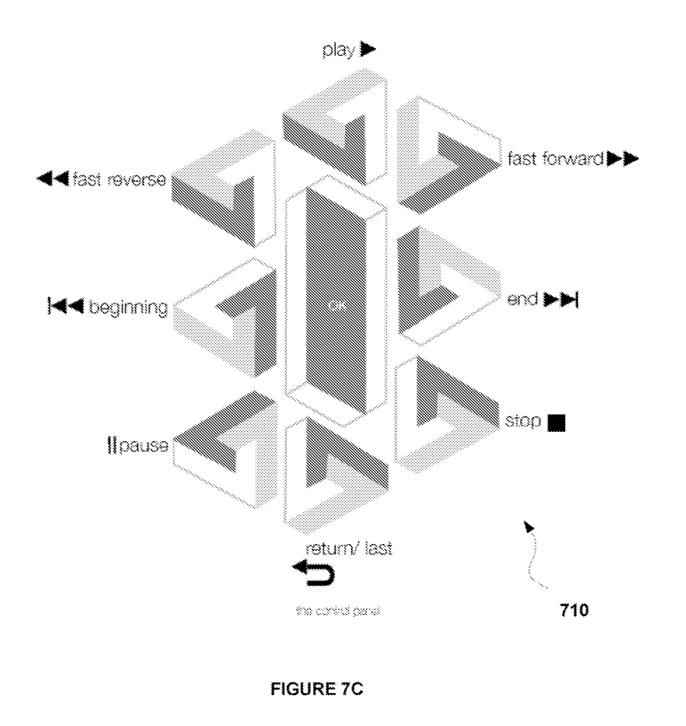

The rationale is, while utilizing the primary viewing window within the engage mode, its resonant effect changes the EDA surrounding it. And, if you're in a text based situation with a website, such as engaging the newsfeed portion of Facebook, and you want to scroll back and forth to review your conversations (or in Facebook's case, up and down), you might also want to review your flight direction, given all the resonant influence on the images change with each input of text. An exemplary control display for the engage mode is shown in FIG. 7C.

Looking again at FIG. 6, closing the control tray, the user enters the engage mode. At this juncture, the system's virtual keyboard 602 joins the user in “flight”, accompanying them as they traverse the various sites they are reviewing.

The engage mode also includes a primary viewing window. This primary viewing window rises into frame in the immediate foreground when the control tray is closed. If a user enters a URL, that site will be the first to occupy the engage mode's primary viewing window. If the user enters a search topic, the first site to come up in the search will occupy the portal. If a user has selected a site from their selections tray, it'll occupy the primary viewing window first.

The engage mode has the ability to interact on a text based level with any site using the system interface. It is the tool for communicating directly with a website, or posting while still in the interface.

Whatever a user responds to within the engage mode resonates throughout the EDA. Thus, the surrounding imagery is always changing in accordance with what's in the primary viewing window.

FIGS. 7A-7C show exemplary icons for the system of one embodiment. FIG. 7A shows icons for the selection of the mode. FIG. 2B show the expansion of the icons of FIG. 7A into the control panel of FIG. 7B. The control panel 710 shown in FIG. 7C can be used to control the three dimensional display.

A 3D game engine can be used to do real-time graphics rendering and provide a way to import assets such as texture maps, camera animation and geometry.

A hybrid rendering approach can be done where the picture frame, as well as the picture content, will be rendered real-time using a 3D game engine while the high quality background can be a pre-rendered movie sequence. This allows for changes in or animation of the location/size/rotation (view alignment) of the picture frames at any point since they will not be part of the re-rendered footage.

The challenges of this approach are:
Background geometry in the movie should occlude real-time picture frames
Visual quality of the picture frames should be close to the demo movie by utilizing bump-maps and reflection maps
Camera synchronization: The rendered geometry should match the movie playback 100%
Refresh Framerate: The playback refresh rate should be as close as possible to a desired frame rate, such as 30 frames/sec. Rendering a background movie with 1024×768 at 30 fps poses a significant challenge.

To achieve the effect of real-time geometry being occluded by pre-rendered (movie) geometry, the selected geometry of the original scene (that was pre-rendered in the movie) can be rendered in a 3D game engine again by only affecting the z-buffer but not the actual image. The effect is that this “occlusion” geometry will act as a mask that cuts out part of the 3D game engine scene that should not be rendered. Since only a small subset of the original geometry needs to be rendered as occluder's (only very few objects occlude picture frames), this will not have too big of an impact on the rendering speed due to high polygon count.

Each frame of the movie can be on a separate “worker” thread into a buffer of several textures. The textures can be cycled in the 3D game engine to render the individual frames onto camera-aligned background geometry.

By displaying the movie sequence as individual textures we can guarantee a match of the 3D game engine geometry and the movie background. The 3D game engine animation time can be matched precisely to the time the current movie frame was rendered, giving synchronization between the 3D game engine geometry and movie background.

User input and reaction of scene geometry (picture frames) to user input can be entirely done with a scripting system. This allows a very convenient way of hit-testing and modifying scene geometry dependent on user input.

Through a 3D game engine plug-in system, a movie texture module can be used to pause/resume movie playback.

The foregoing description of preferred embodiments of the present invention has been provided for the purposes of illustration and description. It is not intended to be exhaustive or to limit the invention to the precise forms disclosed. Many embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalents.

1. A system with a display having a dynamic three dimensional display space to display documents, the display including an automatic visual movement through the three dimensional display space with documents being clickable to allow interaction.

2. The system of claim 1, wherein the display is on a television.

3. The system of claim 1, wherein the documents include WebPages.

4. The system of claim 1, wherein a number of selectable modes control which documents are displayed.

5. The system of claim 1, wherein in a start up mode, personal documents of a user are displayed.

6. The system of claim 1, wherein in an explore mode, documents related to an input search term are displayed.

7. The system of claim 6, wherein in a discover mode, documents related to the input search term are displayed with a greater density in the three dimensional display space than in the explore mode.

8. The system of claim 1, wherein in an engage mode, data input into a selected webpage of the documents is used to control which documents are presented in the three dimensional display space.

9. The system of claim 1, wherein selected documents are stored.

10. The system of claim 9, wherein the stored documents are accessible from a selectable display.

11. The system of claim 9, wherein the stored documents are preferentially displayed in the three dimensional space.

12. A system with a display having a dynamic three dimensional display space to display documents, the display including an automatic visual movement through the three dimensional display space with documents being clickable to allow interaction, wherein data input into a selected webpage of the documents is used to control which documents are presented in the three dimensional display space.

13. The system of claim 12, wherein the data is input into a selected webpage during an engage mode.

14. The system of claim 12, wherein the display is on a television.

15. The system of claim 12, wherein a number of selectable modes control which documents are displayed.

16. The system of claim 12, wherein in a start up mode, personal documents of a user are displayed.

17. The system of claim 12, wherein in an explore mode, documents related to an input search term are displayed.

18. The system of claim 17, wherein in a discover mode, documents related to the input search term are displayed with a greater density in the three dimensional display space than in the explore mode.

19. The system of claim 12, wherein in an engage mode, data input into a selected webpage of the documents is used to control which documents are presented in the three dimensional space.

20. The system of claim 12, wherein selected documents are stored.

21. The system of claim 20, wherein the stored documents are accessible from a selectable display.

22. The system of claim 20, wherein the stored documents are preferentially displayed in the three dimensional display space.
